(19) United States
(12) Patent Application Publication
(10) Pub. No.: US 2017/0148208 A1
(43) Pub. Date: May 25, 2017

(54) METHOD, APPARATUS AND PROGRAM FOR PROCESSING A CIRCULAR LIGHT FIELD

(71) Applicant: ECOLE POLYTECHNIQUE FEDERALE DE LAUSANNE (EPFL), Lausanne (CH)

(72) Inventors: Zhou XUE, Renens (CH); Martin VETTERLI, Grandvaux (CH); Loic Arnaud BABOULAZ, Lausanne (CH)

(73) Assignee: ECOLE POLYTECHNIQUE FEDERALE DE LAUSANNE (EPFL), Lausanne (CH)

(21) Appl. No.: 14/947,690

(22) Filed: Nov. 20, 2015

(51) Int. Cl. G06T 15/50; G06T 15/06

(52) U.S. Cl. CPC G06T 15/506; G06T 15/06; G06T 2215/16

(57) ABSTRACT

Method for processing a circular light field comprising the step of receiving or storing a circular light field matrix, wherein the circular light field matrix comprises pixel data for different circumferential angles and for different incidence angles, wherein each circumferential angle represents one intersection point of a light ray with a circle, and each incidence angle represents an angle of incidence of the light ray in the plane of the circle at the one intersection point; and the step of determining a sub set of pixel data of the circular light field matrix relating to a location by determining for each different circumferential angle an incidence angle related to said location.

### FIELD OF THE INVENTION

The present invention concerns a method, an apparatus and a non-transitory program for processing a circular light field.

### DESCRIPTION OF RELATED ART

As technology improves, people are able to interact with visual displays to experience a new location, activity, etc. through a Virtual Reality (VR) system. This is usually realized by users wearing VR goggles, which combine a screen, gyroscopic sensors and accelerometer. With this device, user is able to watch interactive videos corresponding to the movement of their heads and bodies.

The video contents for these VR system can be divided into two main categories. The first category includes video games and 3-D animations. The objects in the video are generated with 3-D shape and surface texture information specified by creators. The second category is mainly 360° panorama image/video with depth information. Although it offers more promising applications, the quantity and quality of VR contents for a real world environment are quite limited.

There are mainly two disadvantages of existing methods. Firstly, the current VR video requires both panorama image and its depth map. The complexity of image stitching and depth reconstruction is very demanding. Secondly, the ideal VR video should be able to provide any chosen viewing direction at any chosen location. Current methods only offer a limited range of the location change. The rendering is similar to the one used in games and 3-D animations therefore the location change largely depends on the resolution of depth map. As the virtual viewing location moves away from the original shooting location, artifacts soon appears due to the insufficient geometry information of the environment.

Traditionally, light field is represented with a two-plane parameterization where each light ray is uniquely determined by its intersection with two predefined planes parallel to each other. There are two intersections and each intersection is described by its coordinates on these two planes. Therefore the light field for the 3-D world is a 4-D radiance function.

WO15074718 discloses five camera independent representations of light fields which will now be described in relation with FIGS. 1A to 1E: two-planes, spherical, sphere-sphere, sphere-plane and polar respectively.

FIG. 1A illustrates a parametrisation method of a light field with two planes. A ray rᵢ, rⱼ is characterized by the positions where it crosses two planes U-V, Rx-Ry which are parallel to each other. The position on a plane is based on the Cartesian coordinate system for example, or on a polar coordinate system. The first and second planes are placed at z=0, z=1 respectively, where the z axis is perpendicular to the two planes. (Uᵢ,Vᵢ) is the position where Ray rᵢ crosses the first plane U-V and (Rxᵢ, Ryᵢ) is the position where this ray rᵢ crosses the second plane Rx, Ry. The radiance P is determined uniquely from the four parameters Uᵢ,Vᵢ,Rxᵢ, Ryᵢ. Taking into account the z axis, the corresponding ray x,y,z is obtained as

$$( \begin{matrix}x \\ y \\ z\end{matrix} ) = ( \begin{matrix}U + k ( {R}_{x} - U ) \\ V + k ( {R}_{y} - V ) \\ k\end{matrix} )$$

where k is a parameter that can take any real positive value. This method is well-suited for plenoptic cameras having an array of micro-lenses and a sensor plane parallel to each other. One drawback of this representation is that it can't represent light rays which travel parallel to the planes U-V, Rx-Ry.

FIG. 1B illustrates a parametrisation method of a light field with two spheres s1, s2 which circumscribe each other. The two spheres s1, s2 are tangent with each other. A ray rᵢ, rⱼ is parameterized by the outgoing intersecting point (φ1, θ1) with a first sphere s1 and the outgoing intersecting point(φ2, θ2)with the second sphere s2 circumscribed with the first sphere at the first intersecting point (φ1, θ1). (φ1, θ1)is the spherical coordinate with respect to the first sphere and(φ2, θ2)is the spherical coordinate with respect to the second sphere. The ray r is obtained as the line passing through the two points:

$$( \begin{matrix}x \\ y \\ z\end{matrix} ) = ( \begin{matrix}sin ( {θ}_{1} ) cos ( {φ}_{1} ) \\ sin ( {θ}_{1} ) sin ( {φ}_{1} ) \\ cos ( {θ}_{1} )\end{matrix} ) + k ( \begin{matrix}sin ( {θ}_{2} ) cos ( {φ}_{2} ) + sin ( {θ}_{1} ) cos ( {φ}_{1} ) \\ sin ( {θ}_{2} ) sin ( {φ}_{2} ) + sin ( {θ}_{1} ) sin ( {φ}_{1} ) \\ cos ( {θ}_{2} ) + cos ( {θ}_{1} )\end{matrix} )$$

This representation is useful in the case of a plenoptic image captured by an array of cameras arranged on a sphere. This type of camera is typically used for capturing street views. Another advantage of this representation is that all the light rays which intersect the spheres can be described with this representation. However, rays which do not intersect this sphere can't be represented.

FIG. 1C illustrates a parametrisation method of a light field with one single sphere s. It uses two intersecting points (φ1, θ1), (φ2, θ2)of each ray with the sphere s. Assuming that the radius of the sphere s is large enough for the light field, all the rays can be characterized by four angular parameters(φ1, θ1), (φ2, θ2). A ray is obtained as

$$( \begin{matrix}x \\ y \\ z\end{matrix} ) = ( \begin{matrix}sin ( {θ}_{1} ) cos ( {φ}_{1} ) \\ sin ( {θ}_{1} ) sin ( {φ}_{1} ) \\ cos ( {θ}_{1} )\end{matrix} ) + k ( \begin{matrix}sin ( {θ}_{2} ) cos ( {φ}_{2} ) - sin ( {θ}_{1} ) cos ( {φ}_{1} ) \\ sin ( {θ}_{2} ) sin ( {φ}_{2} ) - sin ( {θ}_{1} ) sin ( {φ}_{1} ) \\ cos ( {θ}_{2} ) - cos ( {θ}_{1} )\end{matrix} )$$

This representation is bijective with the spherical representation of FIG. 1B, thus both representations can be convertible to each other without any information loss. Accordingly, its advantages and drawbacks are equivalent to those of the spherical representation.

FIG. 1D illustrates a parametrisation method of a light field with one sphere s and one plane P. A ray rᵢ is represented with the intersecting point (x, y) with the plane P and the angle (φ, θ)of the ray with respect to the sphere coordinate. The plane P is chosen perpendicular to the ray rᵢ and passes through the center of the sphere such that its normal can be represented by a position on a directional sphere. This sphere-plane representation can represent light rays from any position towards any direction, whether or not it crosses the sphere, in contrast to the representations mentioned above. However, the conversion from the sphere-plane representation to the Cartesian coordinate is more complex than the previous representations.

In the polar representation of FIG. 1E, a ray rᵢ is represented with the following four parameters: r, φ, θ, ω. r is the distance between the origin of the coordinate and the closest point A on the ray. (φ, θ) is the coordinate of the closest point A in the spherical coordinate. ω is the angle of the ray within the plane p in which the ray lies, where the plane is perpendicular to the vector from the origin to the closest point A. The polar representation is bijective with the sphere-plane representation thus all the rays fairing in every directions and intersecting or not with the sphere can be represented. Nevertheless, the representation might sound less intuitive since one parameter is distance, the other three are angles from different center points. Similarly to the Sphere plane representation, the conversion to the Cartesian coordinate is complex.

However, all known light field representations have the disadvantage that the rendering of a certain picture from the light field data is complex and error-prone for circular or spherical cases as described above.

### BRIEF SUMMARY OF THE INVENTION

According to the invention, these aims are achieved by means of an apparatus, a method and a computer program for processing circular light fields. A circular light field matrix comprises pixel data for different circumferential angles and for different incidence angles, wherein each circumferential angle represents one intersection point of a light ray with a circle, and each incidence angle represents an angle of incidence of the light ray in the plane of the circle at the one intersection point. This representation of a circular light field allows a very easy rendering of images from the light field for a point of view in the center of the circle to any point.

The light field pixel matrix can be a two-dimensional, three-dimensional, four-dimensional matrix, wherein one dimension corresponds to the different circumferential angles and another dimension to the different incidence angles. Virtual reality acquisition and an image-based algorithm for virtual reality rendering is facilitated, while maintaining and even improving the quality of rendered results.

Further advantageous embodiments are described in the dependent claims.

### BRIEF DESCRIPTION OF THE DRAWINGS

The invention will be better understood with the aid of the description of an embodiment given by way of example and illustrated by the figures, in which:

FIG. 1A to 1E schematically represents different prior art parameterization methods for 4-D light fields.

FIG. 2 shows a 2-D circular light field model.

FIG. 3 shows a derivation for the formula for rendering images from the 2-D circular light field.

FIG. 4 shows the circular light field matrix with three rendered images for different locations.

FIG. 5 shows a 3-D circular light field pixel matrix.

FIG. 6 shows a rendered image in the 3-D circular light field pixel matrix without y-correction.

FIG. 7 shows the rendered image in the 3-D circular light field pixel matrix of FIG. 6 with y-correction.

FIG. 8 shows that the perpendicular distance changes for different camera position.

FIG. 9 shows the case of recording a circular light field at two positions.

FIG. 10 shows a derivation for estimating the relative location of the two recording positions in FIG. 9.

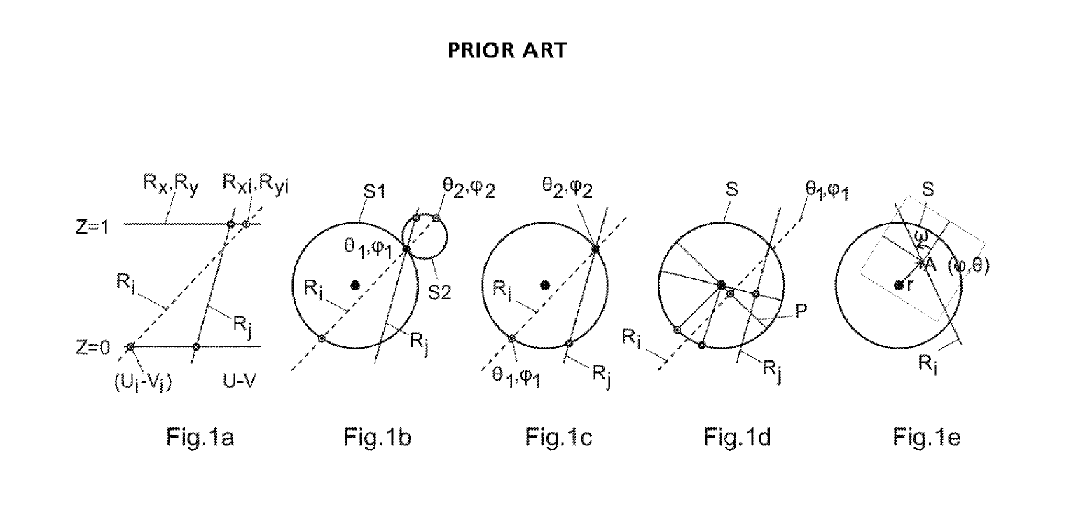

### DETAILED DESCRIPTION OF POSSIBLE EMBODIMENTS OF THE INVENTION

Traditionally, a light field is represented with a two-plane parameterization where each light ray is uniquely determined by its intersection with two predefined planes parallel to each other. There are two intersections and each intersection is described by its coordinates on these two planes. Therefore the light field for the 3-D world is a 4-D radiance function.

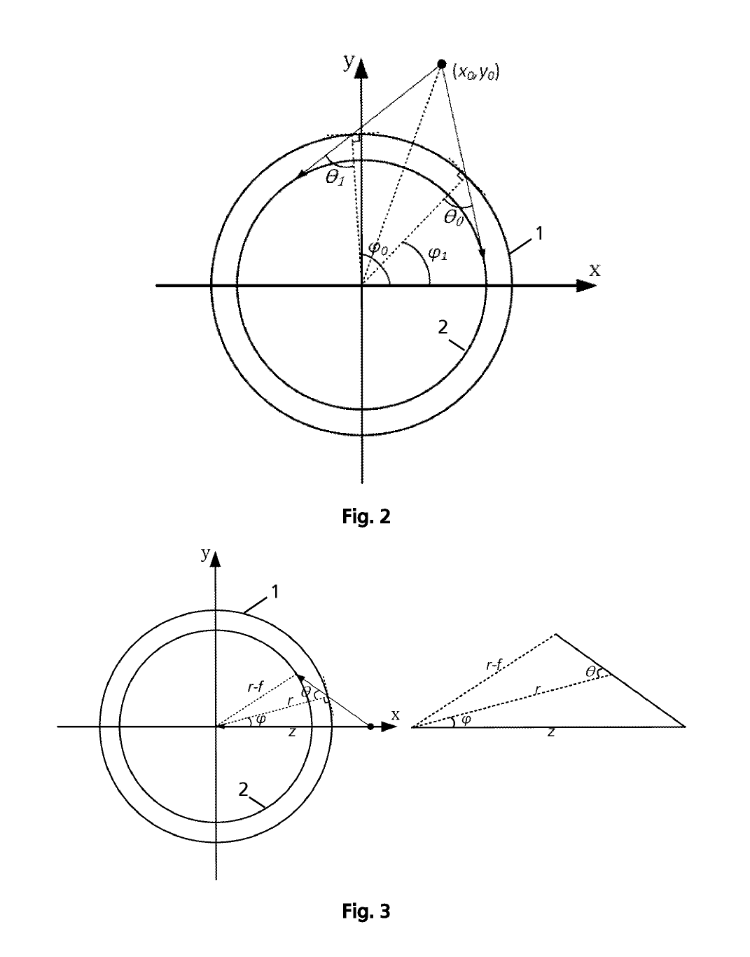

For the sake of simplicity, a 2-D world is discussed where light rays are all on one single plane. Then two planes become two parallel lines whereas the 4-D light field is simplified into a 2-D one without the loss of generality. A Circular Light Field (CLF) to represent the light rays in the 2-D space is proposed and then extended to 3-D world. In the proposed 2-D CLF model/parameterization, each light ray is defined by its intersection with one circle 1 at the circumferential angle φ and the incidence angle θ at the intersection with the circle 1 as shown in FIG. 2. The notation φ in the drawings and the notation φ in the claims and the description refers both to the same circumferential angle and shall have the same meaning in the following. The realization of the CLF is achieved by positioning an array of 1-D cameras on a rig (or for still scenes moving the 1-D camera along a circle and taking the 1D images sequentially). These cameras are located with its optical center or the focal point on the circle 1 (the rig) and their optical axis all pass the center of the circle 1. The radius of the circle 1 is r whereas the focal length of the camera(s) is f. The camera sensor is arranged at a distance f parallel to the tangent of the circle 1 at the intersection point or the circumferential angle φ where the camera center is arranged. Thus, the camera sensor is located with its center at a second circle 2. The parameter x shall be used to represent the coordinates on the 1-D image and x=f·tan θ holds. Then by stacking the 1-D image acquired on the rig, we form a 2-D CLF pixel matrix L(φ, f·tan θ). By normalizing the focal length f to 1, we usually use the a camera independent CLF pixel matrix L(φ, x) to represent the CLF where the circumferential angle φ represents the camera position on the rig and x represents the coordinates on the image sensor representing the incidence angle θ. In order to be camera independent, x should be the real distance of each pixel and not the pixel number. Due to the use of the second concentric circle in the model, the 2-D CLF could also be described as the intersection of a light ray with the two concentric circles 1 and 2.

FIG. 2 shows the case, where the second circle 2 has the radius r-f so that the camera(s) face outwards from the circle center and take a panorama picture. It is however possible to face the camera(s) inwards on the center point of the circle 1 such that the second circle 2 has a larger radius r+f. In the latter case, a CLF pixel matrix regarding an object arranged at the center point of the circle 1 can be recorded. This could be used for example in augmented reality. One example could be to record the CLF of a furniture in order to allow users to insert the picture of the furniture in the picture of the room.

To render new virtual views, the light rays need to be modelled in the CLF. In the traditional light field, any light rays passing through the same position corresponds to slice line in the 2-D data. The slope of the slice line is determined by its perpendicular distance to the original camera plane. Therefore, first the relation between φ and θ in the 2-D data needs to be established to model the light rays in the CLF. Without the loss of generality, two special light rays emitted from a point z meters away from the circle center are chosen as shown in FIG. 3. One light ray intersects with the circle 1 at the circumferential angle 0° and it also passes the circle center. Therefore, the incident angle of this light ray is also 0°. Then, we define the other light ray as (φ, θ). Furthermore, the radius of the circle 1 is defined as r whereas the second circle 2 has a radius r−f. By applying the Sine Law to the triangle as shown in FIG. 3, shown increased on the right, the CLF parametric function c(φ, θ) then can be formulated as

$$tan θ = \frac{sin φ}{- cos φ + r \cdot {z}^{- 1}} , \qquad ( 1 )$$

where tan θ=x. In a more general case, the CLF parametric function c_{z,φC} (φ, x) can be written as

$$x = \frac{sin ( φ - {φ}_{0} )}{- cos ( φ - {φ}_{0} ) + r \cdot {z}^{- 1}} \qquad ( 2 )$$

This function represents all light rays passing the point (z cos φ₀, z sin φ₀) in the 2-D space. Thus, equation (2) allows to compute the images for all virtual view positions (z cos φ₀, z sin φ₀)in the 2-D space.

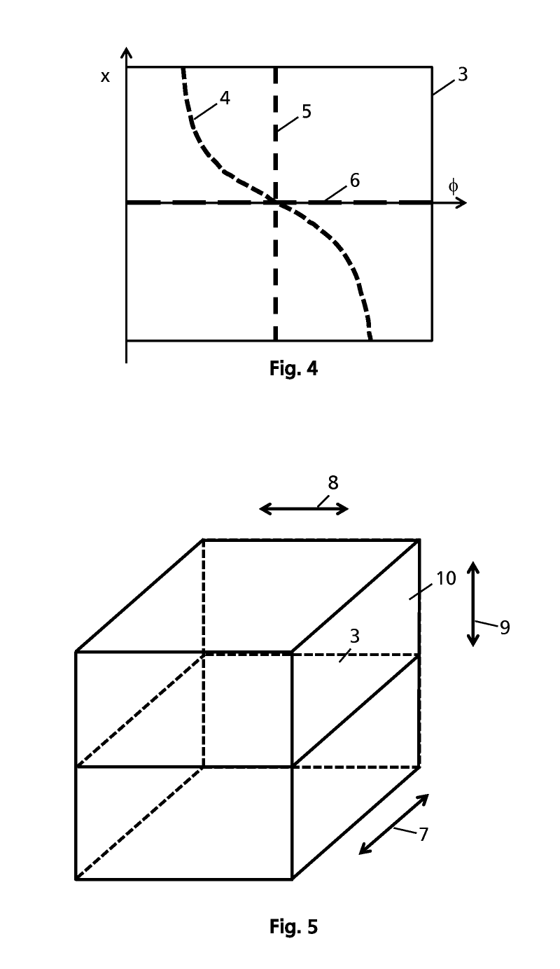

FIG. 4 shows the CLF pixel matrix 3 plotted on the 2 D space, which shows here, without any limitation of the invention, the dimension of the circumferential angle φ in the horizontal direction and the x value, i.e. the incident angle information, for each circumferential angle φ in the vertical direction. In order to yield the image for the virtual view position (z cos φ₀, z sin φ₀), the corresponding curve in the 2-D space has to be calculated by (2) and the pixels of the CLF pixel matrix 3 corresponding to this curve are taken as rendered picture. In other words, a slice, here a line, of the CLF pixel matrix 3 yields the rendered image. This yields high quality image rendering at low computational costs. FIG. 4 shows three curves 4, 5 and 6 computed from equation (2) with the parameters z=+1, r and 0, respectively. When z=+1, the parametric function becomes x=−tan θ. This slice curve 4 represents the parallel light rays from infinity. When z=r, the vertical line 5 is the original image captured by the camera on the rig. When z=0, the parametric function becomes x=0. This slice curve 6 actually is a 360 degree panorama image captured at the circle center. To be more specific, as z decreases from+1 to 0, the corresponding curve changes from slice curve 4 to the slice 5 and then to slice curve 6. When the slice curve goes through the area between slice curves 4 and 5, the corresponding virtual view positions are outside the circle 1. When the slice curve goes through the areas between curves 5 and 6 (top right and low left quarter), the corresponding virtual view positions is outside the outer circle. The field-of-view of the rendered image decreases as z changes from 0 to +1.

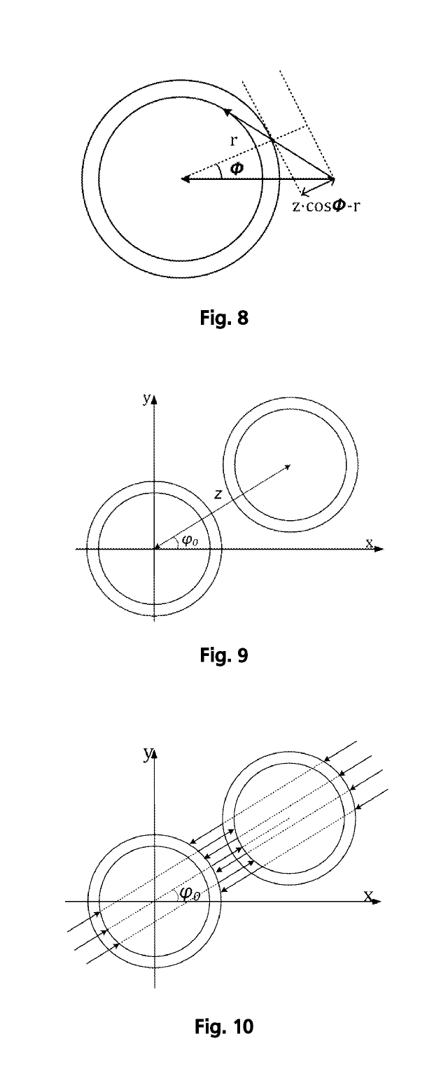

The CLF model was described as a 2-D data acquired by 1-D cameras positioned on a rig. As for the 3-D CLF, it is defined as an image sequence captured by standard cameras instead of 1-D cameras, i.e. 2-D cameras having pixel sensors extending in two dimensions (x and y). The circle plane is perpendicular to each sensor plane of the camera. Furthermore, the central row of each image forms a 2-D CLF which is a slice (2-D matrix) of the 3-D data/matrix. FIG. 5 shows the 3-D CLF pixel matrix, wherein direction 7 represents the circumferential angles φ at which a camera took an image. The two-dimensional image for each circumferential angle φ is stacked in the direction of the circumferential angles φ so that 10 shows the image plane. The direction 8 corresponds to the image direction x, i.e. the direction tangential to the circle 1, and the direction 9 corresponds to the direction y, i.e. rectangular to the plane of the circle 1. The slice 3 corresponds to the 2-D CLF pixel matrix. In 3-D CLFs, light rays are represented with three parameters: φ and (x, y) which are the coordinates on the image plane. The variable y is determined by the origin's height and its perpendicular distance to the image plane. The perpendicular distance changes for different camera position as shown in FIG. 8.

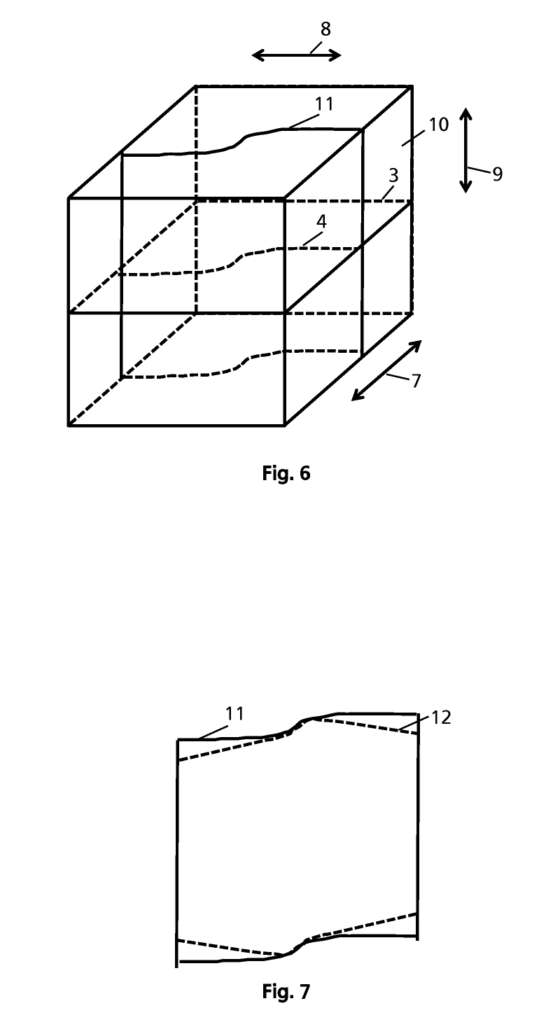

Then we can derive the relation between φ and the projection in the y dimension as

$$y = \frac{h}{z cos ( φ - {φ}_{0} ) - r} , \qquad ( 3 )$$

where h represents the height of the light origin, and the focal length is normalized to 1. To render a virtual view from 3-D CLF, the parametric curves of equation (2) is used to slice each CLF across the y dimension in order to achieve the curvy plane 11 as shown in FIG. 6. However, as shown in (3), the coordinates in the y dimension should change according to the coordinates in the φ dimension. The formulation can be simplified as

$$y = {y}_{0} \frac{z - r}{z cos ( φ - {φ}_{0} ) - r} , \qquad ( 4 )$$

where y₀ represents the original coordinate in the y dimension. In this equation, z and y₀ is determined by the position of the virtual view.

After applying equation (4) in the y dimension, the final rendering result 12 is achieved as shown in FIG. 7.

There are two ways to define and construct a 4-D CLF.

Firstly, each light ray in the 3-D space can be defined by its intersection with two concentric cylinders. This definition is a direct extension of the 3-D CLF L(φ, x, y) and it can be acquired with the same setup. For static scene, the camera rig is moved vertically to add the fourth dimension h and capture the 4-D CLF L(h, φ, x, y). By fixing the variable h, the 4-D CLF becomes exactly the same as the 3-D CLF described in previous sections. Meanwhile, by fixing the variable φ, the 4-D CLF becomes a standard 3-D light field.

Secondly, each light ray in the 3-D space can be defined by its intersection with two concentric spheres. The 4-D CLF is acquired by mounting cameras on a sphere. Thus, the mounting position of the camera under the circumferential angle φ is completed by the dimension of the elevation or polar angle ψ. While the circumferential angle φ has a range of 360° or 2π, the polar angle ψ has only a range of 180° or π. The optical axis of each camera passes through the sphere center. It can also be realized by moving the camera around the fixed radius r of the sphere. The 4-D CLF is represented with L(ψ, φ, x, y). The angle pair ψ and φ can be seen as the elevation and azimuth of each camera on the sphere.

To register two CLFs in 2-D space, we need to estimate two parameters: z₀ and φ₀ as shown in FIG. 9. To be more specific, we need to estimate the distance z₀ between the two circle centers and the circumferential angle φ₀ of the line between the two circle centers. Based on the CLF parametric function, the two unknown parameters can be estimated sequentially.

Firstly, two sets of parallel light rays are defined which pass through both camera rigs coming from two opposite directions as shown in FIG. 10. Then the estimation of φ₀ becomes the alignment of two CLFs in the φ dimension.

Each set of light rays corresponding to a slice curve in the CLF. From the parametric function (2), we can derive the slice curves of the these light rays as

x=−tan(φ−φ₀), x=−tan(φ−φ₀−π) (5)

Thus a subtraction between two CLF pixel matrices while shifting one CLF pixel matrix in the φ dimension by the correct φ₀, the zero lines (5) should clearly appear. In order to remove noise, the constraint that the angle between the two zero curves are π can be used. Thus, the subtraction matrices of the shift angle and the shift angle plus π are added to each other so that noise is averaged out. This shows the two zero lines in the correctly shifted subtraction matrix. Thus, by shifting one of the two CLF pixel matrices over the other CLF pixel matrix and building the respective subtraction matrices, the correct angle φ₀ can be derived.

Secondly, the points on the connecting line between two circle centers are used to estimate the distance z₀. Any point on the connecting line corresponds to two pairs of matching curves. The connecting line corresponds to two pairs of matching areas after a transformation based on the parametric function (2).

1. Method for processing a circular light field:
receiving or storing a circular light field matrix, wherein the circular light field matrix comprises pixel data for different circumferential angles and for different incidence angles, wherein each circumferential angle represents one intersection point of a light ray with a circle, and each incidence angle represents an angle of incidence of the light ray in the plane of the circle at the one intersection point;
determining a sub set of pixel data of the circular light field matrix relating to a location by determining for each different circumferential angle an incidence angle related to said location.

2. Method according to claim 1, wherein the incidence angle for each circumferential angle depends on the distance of said location to the center point of the circle in the plane of the circle.

3. Method according to claim 2, wherein the incidence angle for each circumferential angle φ is based on
$$\frac{sin ( φ - {φ}_{0} )}{- cos ( φ - {φ}_{0} ) + r \cdot {z}^{- 1}} ,$$
wherein z is the distance of said location to the center point of the circle in the plane of the circle, r is the radius of said circle and φ₀ is the circumferential angle at which the line between the location and the center point intersects the circle in the plane of the circle.

4. Method according to claim 1, wherein the pixel data for one circumferential angle for different incidence angles correspond to the pixel data of an optical pixel line sensor arranged parallel to the tangent of the one circumferential angle of the circle.

5. Method according to claim 1, wherein the circular light field matrix comprises pixel data for the different circumferential angles, for the different incidence angles and for different further incidence angles, wherein each further incidence angle represents an angle of incidence of the light ray in the plane being rectangular to the plane of the circle at the one intersection point.

6. Method according to claim 5, wherein the pixel data for one circumferential angle for different incidence angles and for further different incidence angles correspond to the pixel data of an optical pixel array sensor arranged parallel to the tangent of the one circumferential angle of the circle.

7. Method according to claim 6, wherein the pixel data for the one circumferential angle for different incidence angles and for further different incidence angles corresponds to the pixel data of a camera with the pixel array sensor arranged with its optical center or focal point on the circle at the one circumferential angle, wherein the pixel data of the camera are normalized by the focal length.

8. Method according to claim 5, wherein the incidence angle corresponding to one circumferential angle φ is based on
$$\frac{sin ( φ - {φ}_{0} )}{- cos ( φ - {φ}_{0} ) + r \cdot {z}^{- 1}} ,$$
and the further incidence angle corresponding to the one circumferential angle φ is based on
$$\frac{h}{z cos ( φ - {φ}_{0} ) - r} ,$$
wherein z is a distance of said location to the center point of the circle in the plane of the circle, r is the radius of said circle, φ₀ is the circumferential angle at which the line between the location and the center point intersects the circle in the plane of the circle, and h is the height of the location over the circle plane.

9. Method according to claim 5, wherein the circular light field matrix comprises pixel data for the different circumferential angles, for the different incidence angles and for different further incidence angles and for either different heights over the circle plane or for different further circumferential angles of a further circle having the same circle centre as the circle with a plane of the further circle being rectangular to the plane of the circle.

10. Method according to claim 1, wherein the pixel data correspond to data recorded in the radial direction to the outside of the circle.

11. Method according to claim 1, wherein the pixel data correspond to data recorded in the radial direction to the inside of the circle.

12. Apparatus for processing a circular light field comprising:
an input section configured for receiving or storing a circular light field matrix, wherein the circular light field matrix comprises pixel data for different circumferential angles and for different incidence angles, wherein each circumferential angle represents one intersection point of a light ray with a circle, and each incidence angle represents an angle of incidence of the light ray in the plane of the circle at the one intersection point;
a processing section configured for determining a sub set of pixel data of the circular light field matrix relating to a location by determining for each different circumferential angle an incidence angle related to said location.

13. Apparatus according to claim 12, wherein the incidence angle for each circumferential angle φ is based on
$$\frac{sin ( φ - {φ}_{0} )}{- cos ( φ - {φ}_{0} ) + r \cdot {z}^{- 1}} ,$$
wherein z is the distance of said location to the center point of the circle in the plane of the circle, r is the radius of said circle and φ₀ is the circumferential angle at which the line between the location and the center point intersects the circle in the plane of the circle.

14. Apparatus according to claim 12, wherein the circular light field matrix comprises pixel data for the different circumferential angles, for the different incidence angles and for different further incidence angles, wherein each further incidence angle represents an angle of incidence of the light ray in the plane being rectangular to the plane of the circle at the one intersection point.

15. Apparatus according to claim 14, comprising an optical pixel array sensor arranged parallel to the tangent of one circumferential angle of the circle for recording the pixel data for the one circumferential angle, wherein the pixel data for the one circumferential angle for different incidence angles and for further different incidence angles correspond to the pixel data of the optical pixel arry.

16. Apparatus according to claim 15, comprising a camera with the pixel array sensor arranged with its optical center or focal point on the circle at the one circumferential angle, wherein the pixel data of the camera are normalized by a focal length of the camera.

17. Apparatus according to claim 14, wherein the incidence angle corresponding to one circumferential angle φ is based on
$$\frac{sin ( φ - {φ}_{0} )}{- cos ( φ - {φ}_{0} ) + r \cdot {z}^{- 1}} ,$$
and the further incidence angle corresponding to the one circumferential angle φ is based on
$$\frac{h}{z cos ( φ - {φ}_{0} ) - r} ,$$
wherein z is a distance of said location to the center point of the circle in the plane of the circle, r is the radius of said circle, φ₀ is the circumferential angle at which the line between the location and the center point intersects the circle in the plane of the circle, and h is the height of the location over the circle plane.

18. Apparatus according to claim 14, wherein the circular light field matrix comprises pixel data for the different circumferential angles, for the different incidence angles and for different further incidence angles and for either different heights over the circle plane or for different further circumferential angles of a further circle having the same circle centre as the circle with a plane of the further circle being rectangular to the plane of the circle.

19. Apparatus according to claim 12, wherein the apparatus is a virtual reality system.

20. Non-transitory program for processing a circular light field configured to perform the following steps when excecuted by a processor:
receiving or storing a circular light field matrix, wherein the circular light field matrix comprises pixel data for different circumferential angles and for different incidence angles, wherein each circumferential angle represents one intersection point of a light ray with a circle, and each incidence angle represents an angle of incidence of the light ray in the plane of the circle at the one intersection point;
determining a sub set of pixel data of the circular light field matrix relating to a location by determining for each different circumferential angle an incidence angle related to said location.

21. Non-transitory program according to claim 20, wherein the incidence angle for each circumferential angle φ is based on
$$\frac{sin ( φ - {φ}_{0} )}{- cos ( φ - {φ}_{0} ) + r \cdot {z}^{- 1}} ,$$
wherein z is the distance of said location to the center point of the circle in the plane of the circle, r is the radius of said circle and φ₀ is the circumferential angle at which the line between the location and the center point intersects the circle in the plane of the circle.

22. Non-transitory program according to claim 20, wherein the circular light field matrix comprises pixel data for the different circumferential angles, for the different incidence angles and for different further incidence angles, wherein each further incidence angle represents an angle of incidence of the light ray in the plane being rectangular to the plane of the circle at the one intersection point, wherein the incidence angle corresponding to one circumferential angle φ is based on
$$\frac{sin ( φ - {φ}_{0} )}{- cos ( φ - {φ}_{0} ) + r \cdot {z}^{- 1}} ,$$
and the further incidence angle corresponding to the one circumferential angle φ is based on
$$\frac{h}{z cos ( φ - {φ}_{0} ) - r} ,$$
wherein z is a distance of said location to the center point of the circle in the plane of the circle, r is the radius of said circle, φ₀ is the circumferential angle at which the line between the location and the center point intersects the circle in the plane of the circle, and h is the height of the location over the circle plane.

23. Method for processing a circular light field:
receiving or storing a first circular light field matrix, wherein the first circular light field matrix comprises pixel data for different circumferential angles and for different incidence angles, wherein each circumferential angle represents one intersection point of a light ray with a first circle with a first center point, and each incidence angle represents an angle of incidence of the light ray in the plane of the first circle at the one intersection point;
receiving or storing a second circular light field matrix, wherein the second circular light field matrix comprises pixel data for different circumferential angles and for different incidence angles, wherein each circumferential angle represents one intersection point of a light ray with a second circle with a second center point, and each incidence angle represents an angle of incidence of the light ray in the plane of the second circle at the one intersection point;
determining a desired circumferential angle of the intersection point of the line connecting the first center point and the second center point at the first or second circle by
subtracting the first circular light field matrix and the second circular light field matrix, wherein one of the first circular light field matrix and the second circular light field matrix is shifted by a shift angle along the circumferential angle;
repeating the subtraction process for several different shift angles;
selecting one of the shift angles as desired circumferential angle.

24. Method according to step 23, wherein the step of determining the desired circumferential angle comprises the further step of adding the subtraction matrix related to the selected shift angle to the subtraction matrix related to the selected shift angle plus π.
